(19) United States
(12) Patent Application Publication
(10) Pub. No.: US 2004/0241275 A1
(43) Pub. Date: Dec. 2, 2004

(54) Hollow nickel mold members for use in blow molding

(76) Inventors: Michael J. Ryan, Aurora (CA); Reinhart Weber, Penetanguishene (CA)

Correspondence Address: Michael S. Leonard, Bell, Boyd & Lloyd LLC, P.O. Box 1135, Chicago, IL, 60690-1135, US

(21) Appl. No.: 10/714,419

(22) Filed: Nov. 12, 2003

(30) Foreign Application Priority Data
May 30, 2003 (CA) 2,430,546

(51) Int. Cl. B29C 49/48; B29C 49/64

(52) U.S. Cl. 425/526; 249/80

(57) ABSTRACT

Hollow nickel blow molds produced by nickel vapor deposition have an inner wall defining a mold cavity and an integral outer wall defining a hollow interior therebetween for coolant fluid. The outerwall has inlet and outlet ports therein for admission and exhaustion of the coolant fluid. A holder is provided for mounting the molds in a blow molding machine.

### FIELD OF THE INVENTION

This invention relates to blow molding, and in particular, to molds for producing hollow molded articles of plastics material.

### BACKGROUND OF THE INVENTION

It has hitherto been known in blow molding to provide a mold member which is operatively secured to a holder, with a plurality of, and typically two, mating mold members being operatively moveable, by movement of the holders to which the mold members are secured. The mating mold members move between a closed condition in which an article of plastics material may be blow molded within mold cavities of the mold members, and an open condition in which blow molded articles of plastics material may be removed from the mold cavities. In such hitherto known arrangements, each mold member is secured in thermal contact with its associated holder, and the holder is provided with passages for the flow of coolant fluids therethrough. This flow of coolant fluid, which may be, for example, water or air, serves to set the article of plastics material after the blow molding thereof within the mold cavities in the mold members. The coolant fluid flow passages may also serve for the flow of heating fluid to heat the mold or portions of it during the blow molding process.

It is a disadvantage of such hitherto known arrangements that to ensure substantially uniform cooling of the article of plastics material after the blow molding thereof, without hot spots or cold spots occurring, the dimensions of the coolant flow passages in the holders are relatively critical, so that achieving this substantially uniform cooling of the article of plastics material may not readily be achieved by the securement of each mold member to its associated holder.

### SUMMARY OF THE INVENTION

In the present invention, the mold member itself is a hollow body made of nickel, with inlet and outlet ports therein for the flow of coolant fluid through the mold member.

In accordance with the present invention, there is provided a mold member for use in blow molding articles of plastics material, the mold member comprising a hollow body having an inner wall defining a mold cavity and an integral outer wall joined thereto to define a hollow interior between the inner wall and the outer wall. The outer wall defines therein an inlet port for admission of coolant fluid into the hollow interior and an outlet port for exhausting coolant fluid from the hollow interior. Also, the mold member is formed of nickel.

### BRIEF DESCRIPTION OF THE DRAWINGS

In order that the invention may be more clearly understood and more readily carried into effect, preferred embodiments of the invention will now, by way of example, be more fully described with reference to the accompanying drawings in which:

FIG. 1 is a perspective view of a mold member according to a preferred embodiment of the present invention looking toward the inner wall;

FIG. 2 is a plan view of the mold member of FIG. 1;

FIG. 3 is a perspective view of the mold member of FIG. 1 looking toward the outer wall;

FIG. 4 is a plan view of the of the mold member as seen in FIG. 3;

FIG. 5 is a side view of the mold member;

FIG. 6 is an end view of the mold member as viewed in the direction of the arrow 6 in FIG. 3;

FIG. 7 is an end view of the mold member as viewed in the direction of the arrow 7 in FIG. 3;

FIG. 8 is a cross-sectional view taken along the lines 8-8 in FIGS. 1 and 2;.

FIG. 9 is an enlarged cross-sectional view taken along lines 9-9 in FIG. 2;

FIG. 10 is an enlarged cross-sectional view taken along lines 10-10 in FIG. 2;

FIG. 11 is an enlarged cross-sectional view taken along lines 11-11 in FIG. 4;

FIG. 12 is a view corresponding to FIG. 2 but with the mold member secured to an associated holder;

FIG. 13 is a side view in the direction of arrow 13 in FIG. 12;

FIG. 14 is an end view in the direction of the arrow 14 in FIG. 12;

FIG. 15 is a cross-sectional view taken along lines 15-15 in FIG. 12;

FIG. 16 is an enlarged cross-sectional view taken along lines 16-16 in FIG. 12;

FIG. 17 is an enlarged cross-sectional view taken along lines 17-17 in FIG. 12;

FIG. 18 is a perspective view similar to FIG. 1, but showing another preferred embodiment of the present invention used to extrusion blow mold handleware products;

FIG. 19 is a perspective view of the mold member shown in FIG. 18 looking toward the outer wall;

FIG. 20 is a diagrammatic perspective view of another preferred embodiment of the present invention used to produce stretch blow molded articles;

FIG. 21 is a perspective view, partly broken away, of the embodiment shown in FIG. 20, but without the bottom mold member in place;

FIG. 22 is a perspective cross-sectional view taken along lines 22-22 of FIG. 21; and

FIG. 23 is a perspective view of the mold member shown in FIGS. 20 to 22 looking toward the outer wall.

### DETAILED DESCRIPTION OF THE DRAWINGS

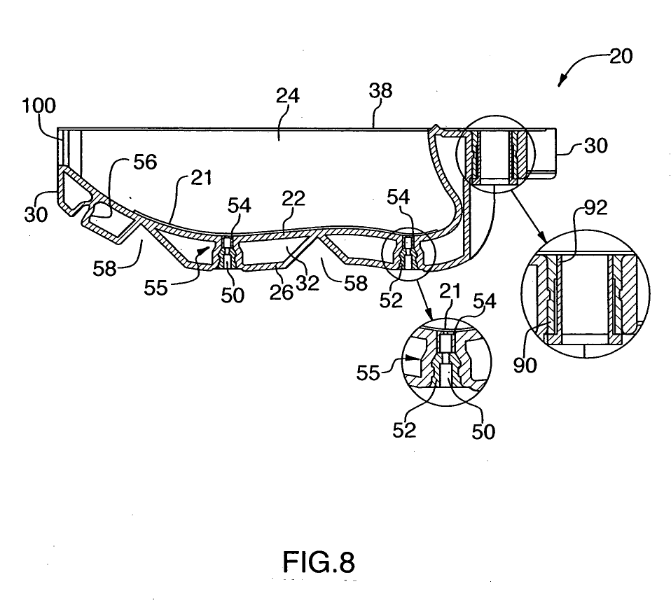

Referring to the drawings, 20 denotes generally a mold member for use in blow molding articles of plastics material, particularly, in an extrusion blow molding process. Mold member 20 is in the form of a hollow body having an inner wall 22 which defines a mold cavity 24. The mold member 20 also has an outer wall 26 which includes peripheral side walls 28 and end walls 30. A hollow interior 32 (see FIG. 8) is provided between the inner wall 22 and the outer wall 26 of the mold member 20. The mold member 20 is made of nickel formed by nickel vapor deposition on cavity walls of closed master mold members or mandrels (not shown). In this nickel vapor deposition process, nickel tetracarbonyl gases —Ni(Co)₄— decomposes into pure metallic nickel and carbon monoxide, and the nickel is deposited on heated cavity walls of the closed master mold members or mandrels, with the amount of nickel which is so deposited on these cavity walls determining the thickness of the inner wall 22 and the outer wall 26 of the mold member 20. The wall thickness typically ranges between 2 and 6 millimetres, depending on the size of the mold. Forming the mold member 20 by nickel vapor deposition in this manner results in there being no need for machining and hand polishing and finishing of the mold cavity 24 as is required in the manufacture of conventional mold members. As will be appreciated, such machining and hand polishing and finishing in the manufacture of conventional mold members is extremely labour intensive and substantially increases the costs of manufacture of conventional mold members.

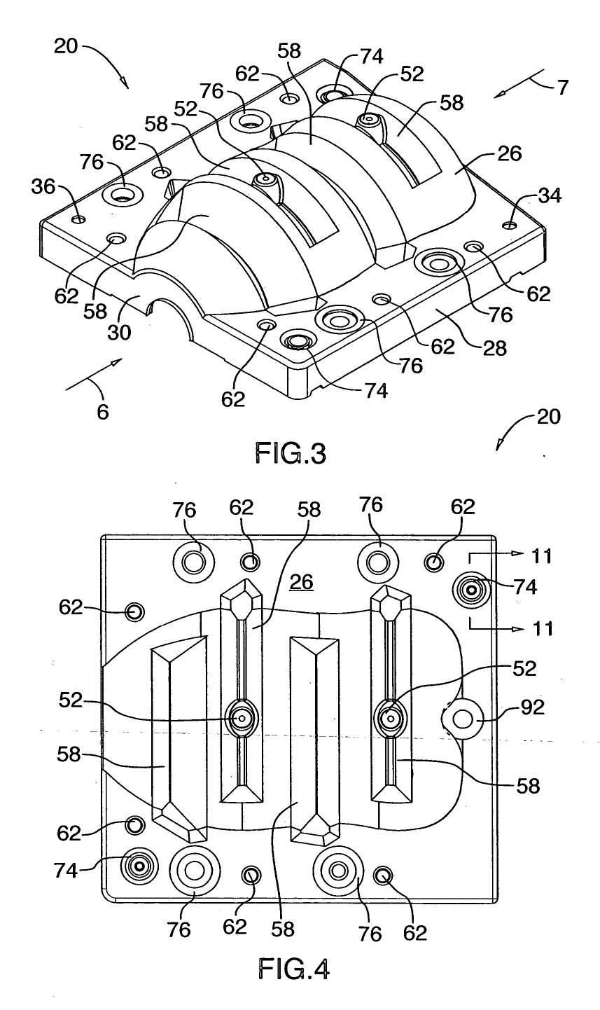

As shown best in FIGS. 3 and 16, the outer wall 26 of the mold member 20 is provided with at least one inlet port 34 for admission of coolant fluid which may, for example, be water or air to the hollow interior 32 of the mold member 20, and with at least one outlet port 36 for exhausting this coolant fluid from the hollow interior 32. These inlet and outlet ports 34, 36 are the same ports used to make mold member 20 in the nickel vapor deposition process. The location of such ports is chosen to obtain uniform mold wall thickness in the nickel vapor deposition process, and also to obtain uniform cooling of mold member 20 in the blow molding process. As mentioned above, the term “coolant” as used herein is intended to include both heating and cooling fluids, and both liquids and gases.

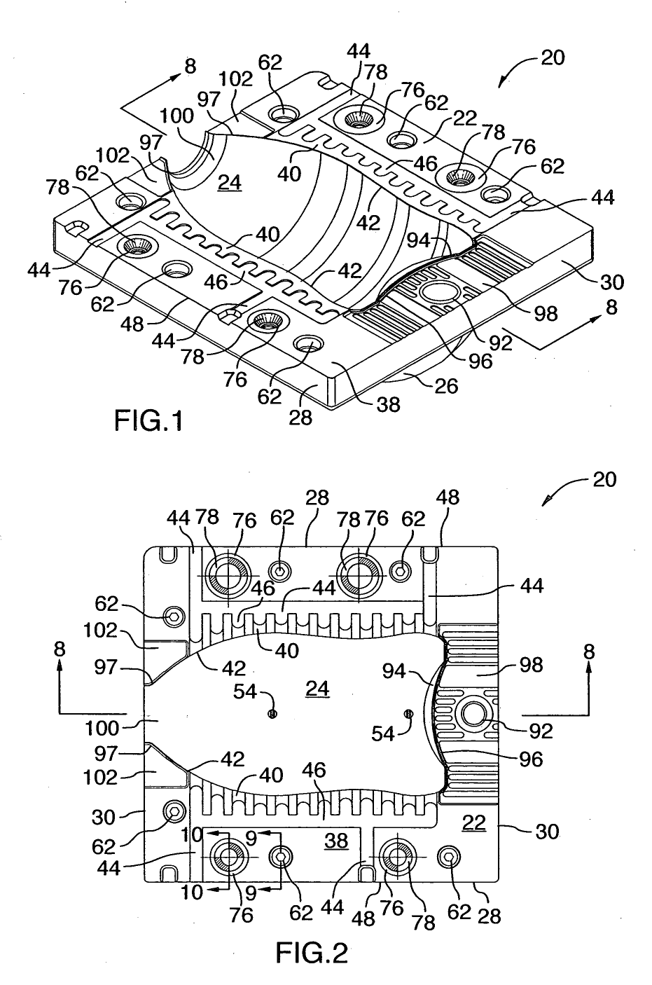

The inner wall 22 of the mold member 20 has an inner face 38, sometimes referred to as the parting line, with a slightly recessed portion 40 (see FIG. 1) extending along and communicating with each lateral edge 42 of the mold cavity 24. These slightly recessed portions 40, which vary in the depth between 0.0015 and 0.004 inches, each include further recessed grooving or grooves 44 which typically is between 0.020 and 0.030 inches deep. In the preferred embodiment illustrated in the drawings, recessed grooves 44 includes finger grooves 46, with the grooving 44 extending to the peripheral side edges 48 of the parting line inner face 38 of the inner wall 22 of the mold member 20. Recesses 40 and grooves 44, 46 permit venting or exhaustion of air from within the mold cavity 24 during blow molding therein of articles of plastics material as hereinafter more fully described.

If desired, the mold member 20 may, during the manufacture thereof, be provided with at least one orifice 50 which, as seen best in FIG. 8, preferably includes a threaded insert 52 of, for example, steel, which is encapsulated in the nickel during the nickel vapor deposition formation of the mold member 20. Insert 52 is provided to attach a vacuum line thereto. The inner portion of the orifice 50 holds a porous vent plug 54 which is added later to retain a printed label 21 of plastics material against the wall of the mold cavity 24 by the application of a low vacuum to the orifice 50. This is referred to as in-mold labelling. This printed label is integrally incorporated into the article of plastics material during the blow molding thereof. If in-mold labelling is not desired or required, vent plug 54 can be used for venting or exhausting air from the mold during the blow molding process, or it could be replaced by a non-porous plug or a plug containing a date stamp or logo. Any number of plugs 54, or none at all, can be used in mold member 20 at any location desired. The encapsulated inserts 52 and plugs 54 are referred to herein as integral connector assemblies 55 that extend between the mold member inner and outer walls 22, 26 and they also provide support therebetween.

Furthermore, in the manufacture of the mold member 20, the outer wall 26 may optionally be formed with at least one additional hollow support 56 which is of generally frusto-conical form and extends across the hollow interior 32 of the mold member 20. Supports 56 are integrally joined with the inner wall 22. The supports 56 serve to reinforce the mold member 20 and prevent the mold walls from collapsing together during the blow molding process, and supports 56 also operatively cause cooling fluid flow augmentation, such as turbulence, in the coolant fluid flow within the hollow interior 32. Further to cause turbulence in this coolant fluid flow within the hollow interior 32 of the mold member 20, the outer wall 26 adjacent to the mold cavity 24 may be provided with grooves 58 (see FIG. 3) which protrude into the hollow interior 32 of the mold member 20. Turbulence in the coolant fluid flow within the hollow interior 32 of the mold member 20 may be desirable to ensure substantially uniform cooling of the article of plastics material after the blow molding thereof, and also to ensure substantially uniform heating of the article of plastics material during the blow molding thereof if the hollow interior 32 is also used for flow of a heating fluid to heat portions of the mold during the blow molding thereof. If heating is required, heating elements (not shown) can also be encapsulated into mold member 20 during the nickel vapor deposition process. In this manner, undesirable hot spots or cold spots during the molding of the article of plastics material in the blow molding process, and the subsequent cooling of the article after the blow molding thereof, can be avoided.

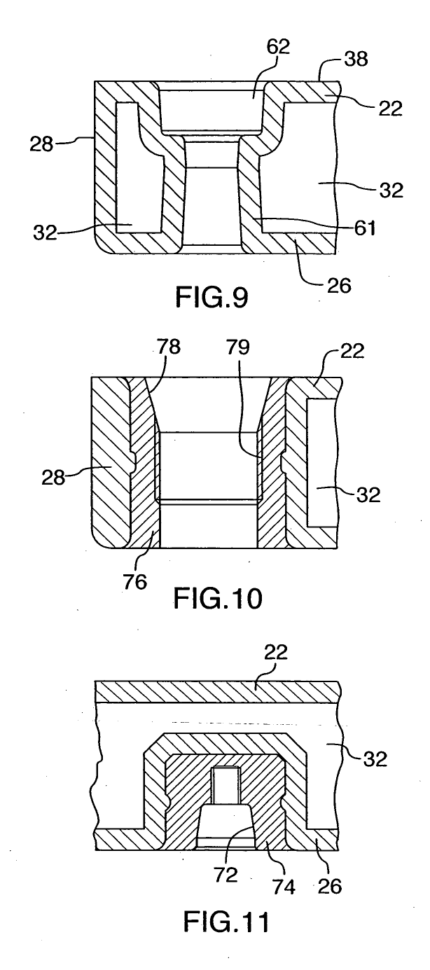

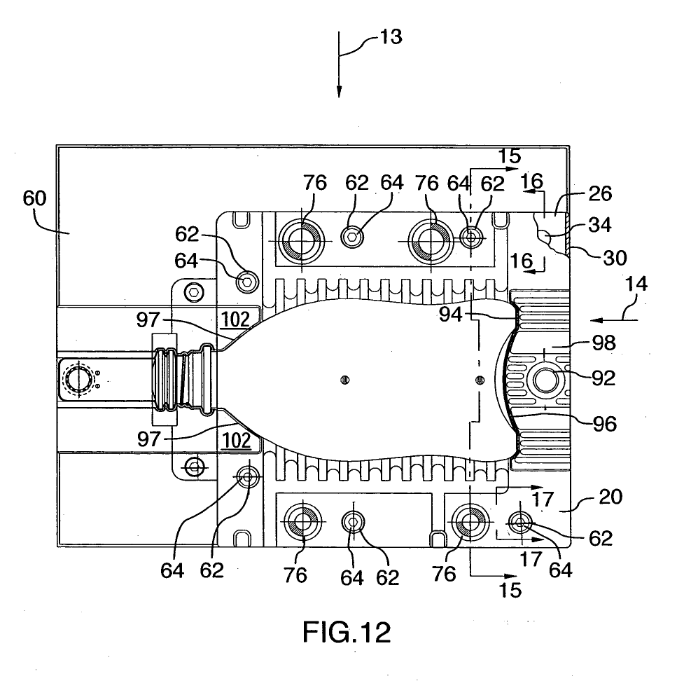

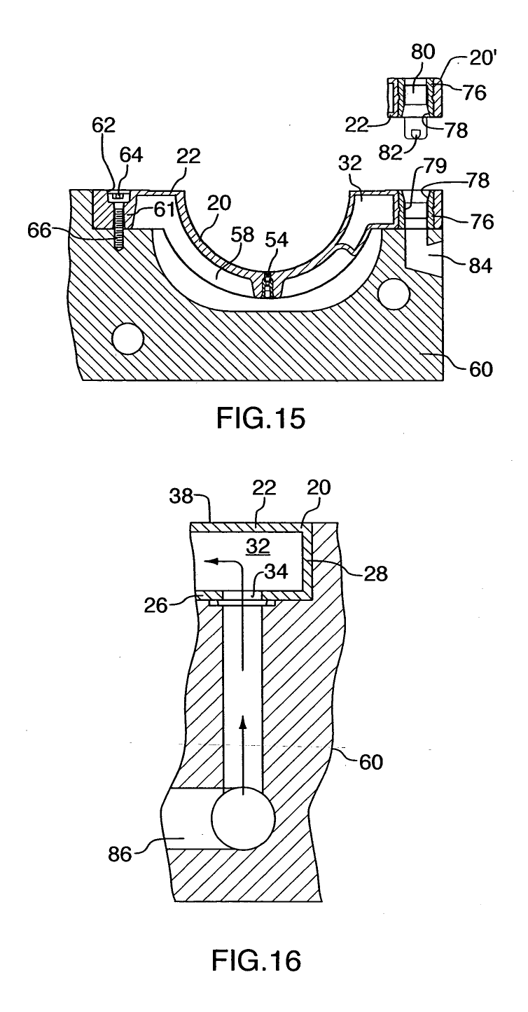

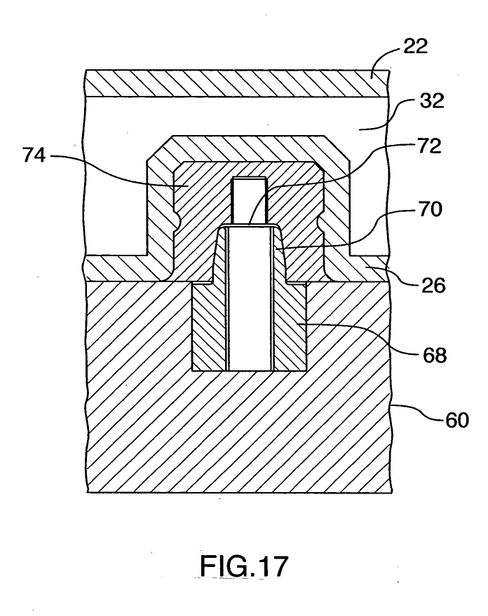

As shown in FIGS. 12 to 17, and 9, the mold member 20 is operatively releasably secured to a holder which is denoted generally by the reference numeral 60 and which may be formed of aluminum. To facilitate this releasable securement of the mold member 20 to the holder 60, the mold member 20 is preferably provided during the manufacture thereof with stand-offs 61 (see FIG. 9), each having a shouldered recess 62, as seen best in FIGS. 2, 9, 12 and 15. Recess 62 is preferably of tapered form, there being six such recesses 62 in the preferred embodiment shown in the drawings. Cap screws 64 (see FIGS. 12 and 15), or other types of threaded fasteners, are located in recesses 62 and screwed into threaded bores 66 in holder 60 to retain mold member 20 in holder 60.

Referring next to FIGS. 17, 11, 12 and 3, holder 60 has protruding locator pins 68 mounted therein at appropriate locations. Locator pins 68 have tapered ends 70 that engage tapered recesses 72 formed in steel bushings 74 encapsulated into mold member 20 during the nickel vapor deposition process of making mold member 20. The pins 68 and bushings 74 accurately position the mold member 20 in the holder 60, or in other words, provide for the shell registration of mold member 20 in holder 60.

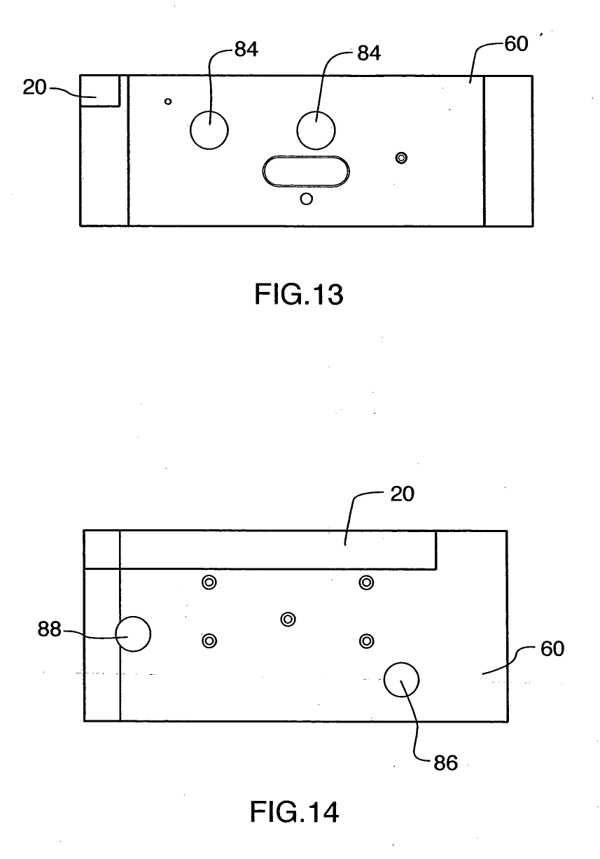

Referring next to FIGS. 1, 2, 10 and 15, the mold member 20 is formed during the manufacture thereof, as hereinbefore described, with encapsulated steel bushings 76 having tapered entrance portions 78 and threaded central portions 79 adapted to threadably receive locator pins 80 (see FIG. 15). Locator pins 80 have opposed flats 82 to assist in gripping them and threading them into bushings 76. Pins 80 can be mounted in either of the mating mold members 20, and they serve to ensure accurate alignment of the mold members 20, to maintain them in registration as the blow mold opens and closes during a blow molding operation. As seen in FIGS. 13 and 15, in whichever blow mold member 20 that does not have the locator pins 80, holder 60 is formed with bleed-off passages 84 to get rid of any stray plastics material that may be pushed through the bushing 76 by the locator pins 80.

Referring next to FIGS. 14 to 16, holder 60 is formed with coolant inlet passages 86 that communicate with the mold member inlet ports 34, and coolant outlet passages 88 that communicate with the mold member outlet ports 36.

Referring again to FIGS. 1 and 8, mold member 20 has another encapsulated sleeve 90 to accommodate a brass bushing 92, which in turn accepts a knock-out or punch (not shown) to assist in the removal of the blown container from the mold.

In operation, the mold member 20 together with the associated holder 60 are mounted with a complementary mold member 20′ (only a portion of which is shown in FIG. 15) together with its associated holder such that by actuation of the holders the mold members 20 and 20′ may be moved between a closed condition in which the inner faces 38 of the inner walls 22 thereof are in abutting contact, and an open condition in which these inner faces 38 of the inner walls 22 thereof are separated. The mold member 20′ normally is of corresponding form to the mold member 20 as described above, except that it is a mirror image thereof. However, the mold cavities 24 could be different in the two half mold members 20, 20′, if it is desired to produce a blow molded article that is not symmetrical.

As mentioned above, mold members 20 are used for extrusion blow molding, where the article may be formed by continuous blow molding in which a tube of the plastics material is inserted between the mold cavities 24 of the mold members 20 and 20′ while these mold members 20 and 20′ are in the open condition. The free end of the tube of plastics material extends beyond the base end 94 of the mold cavities 24 at which the inner face of the inner wall 22 of one or both of the mold members 20 and 20′ presents a knife edge 96, so that when the mold members 20 and 20′ are moved to the closed condition and the tube of plastics material is at its softening temperature, the free end portion of the tube of plastics material is severed with the severed end of the tube being sealed together. Similar knife edges 97 are provided at the neck portion 100 of mold member 20 for a similar purpose. The inner face 38 of the inner wall 22 of each mold member 20 and 20′ has recessed portions 98 and 102 for accommodating the severed free end and side portions of the tube for subsequent disposal or recycling. Pressurized air is supplied to the interior of the tube of plastics material to form this tube into the blow molded article. The article is again removed when the mold members 20 and 20′ are separated subsequent to the plastics material of the finished article being set by the flow of coolant fluid through the hollow interior 32 of each mold member 20 and 20′.

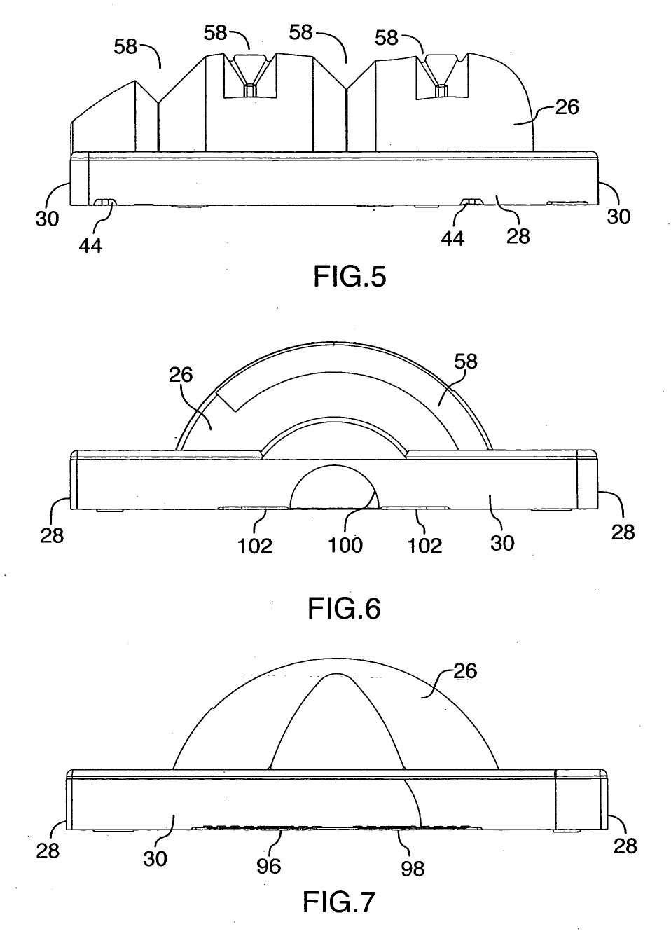

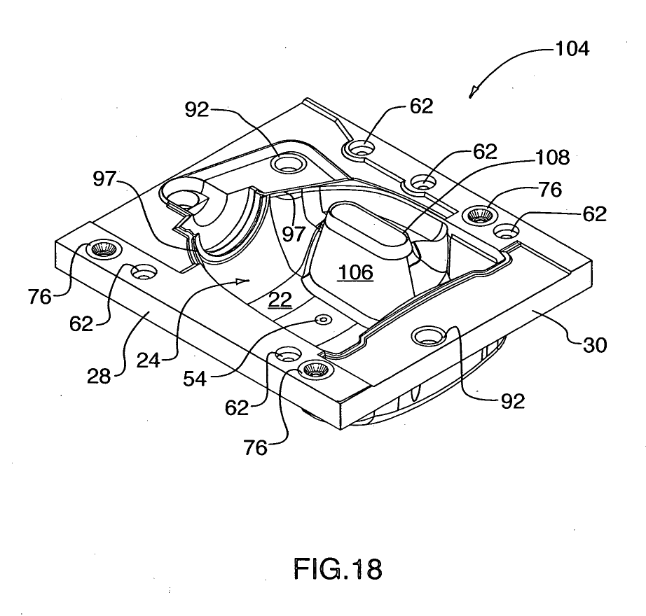

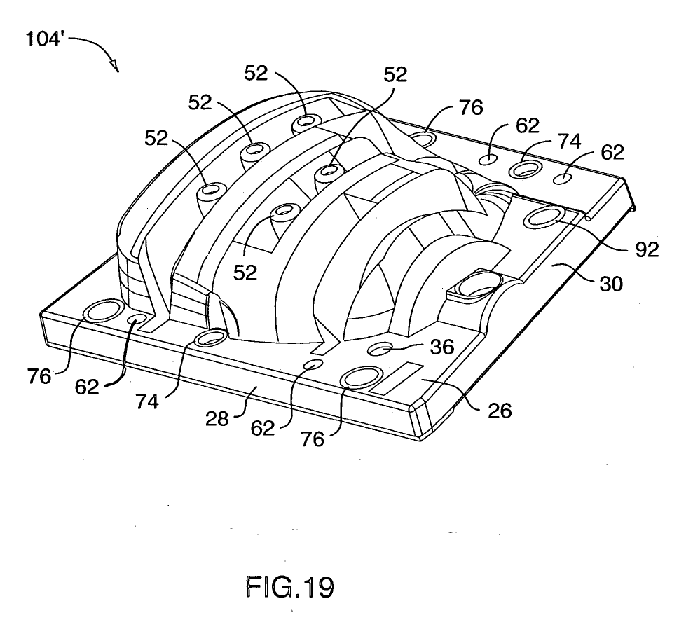

FIGS. 18 and 19 show another preferred embodiment of a mold member 104 which is used for the extrusion blow molding of handleware products. Like reference numerals are used in FIGS. 18 and 19 to indicate components that are similar to those of the embodiments shown in FIGS. 1 to 17.

For forming by blow molding so-called handleware articles of plastics material which have an integral handle opening, the mold cavity 24 of each mold member 104 is provided with an upstanding handle protrusion 106 such that when the tube of plastics material is inserted into the cavity formed by the mold cavities 24 of the mold members 104 and 104′ and the mold members are thereafter moved to the closed condition, a portion of the tube of plastics material is collapsed by the handle protrusions 106. This collapsed portion of the tube between the handle protrusions 106 is severed by a knife edge 108 extending around the periphery of the handle protrusion 106 of one or both of the mold members 104 and 104′. This collapsed portion of the tube of plastics material which has been severed is subsequently removed and discarded or recycled after the plastics material of the finished handleware article has been set and the mold members 104 and 104′ have been moved to the open condition.

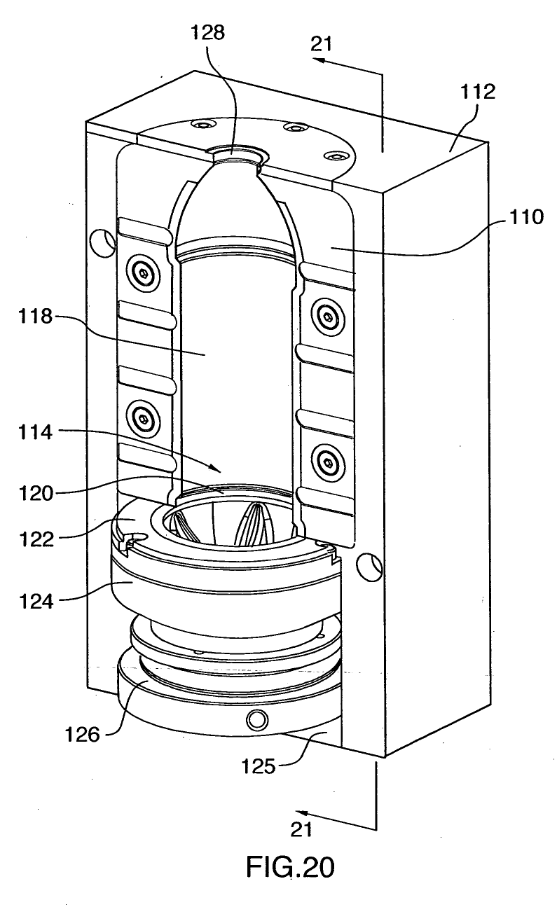

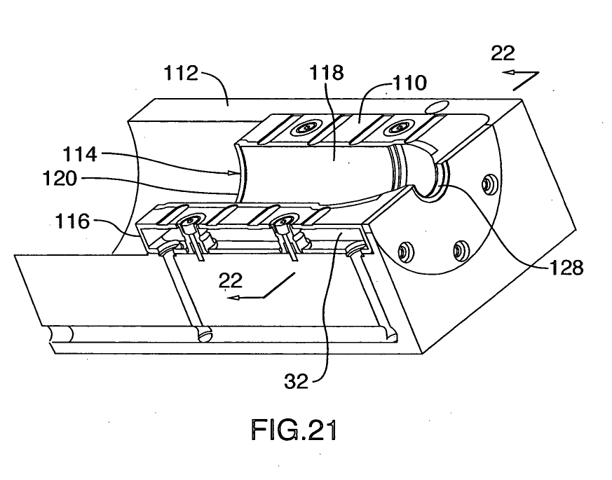

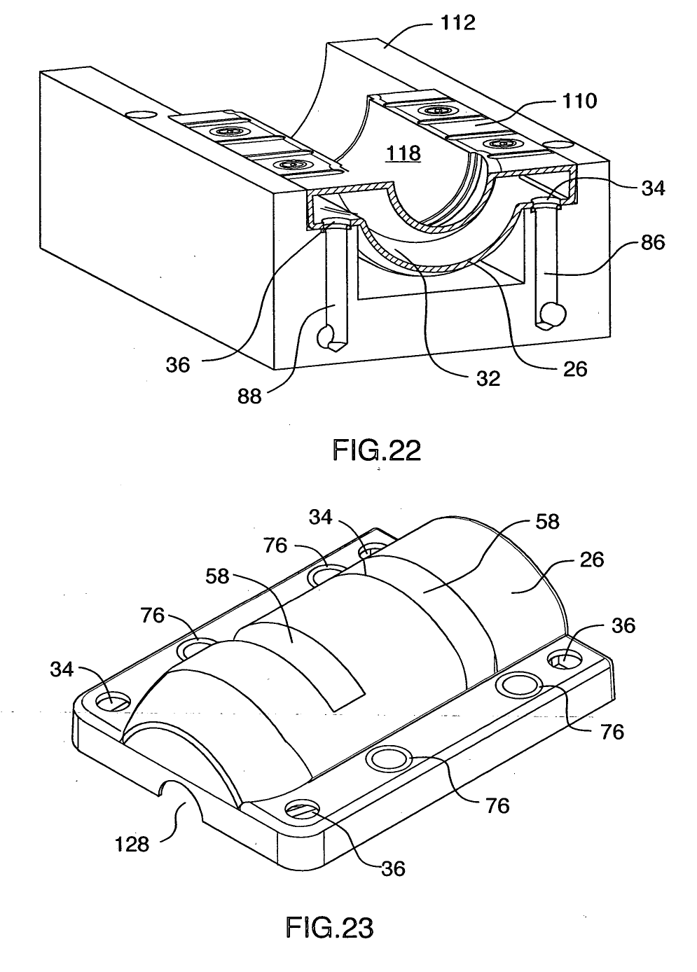

Referring next to FIGS. 20 to 24, a stretch blow mold member 110 is shown mounted in a holder 112. Stretch blow mold 110 is similar to mold member 20 except that mold member 110 has an open base end portion 114. Base end portion 114 has an end wall 116 (see FIG. 21), but the mold cavity 118 has an open bottom end portion 120.

Open bottom end portion 120 is closed by a base mold member 122 which is adapted to cooperate with the hollow bodies of the mating mold members 110 and 110′ to form a closed stretch blow mold. Holder 112 also has base members 124, 125 and 126 to hold base mold member 122 in place.

With the mold members 110, 110′ and 122 in the closed condition, a parison (not shown) of the plastics material to be blow molded into the article is inserted through an opening 128 into the cavity formed by the mold cavities 118, with the parison heated to the softening temperature of the plastics material, a stretch rod (not shown) is inserted into the parison to stretch the parison. Pressurized air is then blown into the parison to form the blow molded article within the cavity constituted by the mold cavities 118. It will be appreciated that no knife edges are provided in mold members 110, because they are not needed since the parison is just blowing out to fill the mold cavities 118. Thereafter, coolant fluid is caused to flow through the hollow interior 32 of each mold member 110 and 110′ to set the plastics material of the blow molded article, and by actuation of the holders 112, 124, 125 and 126, these mold members are then separated with the finished blow molded article being removed.

As will be apparent to those skilled in the art in light of the foregoing disclosure, many alterations and modifications are possible in the practice of this invention without departing from the spirit or scope thereof. Accordingly, the scope of the invention is to be construed in accordance with the substance defined by the following claims.

1. A mold member for use in blow molding articles of plastics material, the mold member comprising: a hollow body having an inner wall defining a mold cavity and an integral outer wall joined thereto to define a hollow interior between said inner wall and said outer wall; the outer wall defining therein an inlet port for admission of coolant fluid into said hollow interior and an outlet port for exhausting coolant fluid from said hollow interior; and the mold member being formed of nickel.

2. A mold member according to claim 1 wherein the inner wall has a uniform wall thickness in the area of the mold cavity.

3. A mold member according to claim 2 wherein the thickness of the inner wall is between 2 and 6 millimeters.

4. A mold member according to claim 1 wherein the mold member is produced by nickel vapor deposition.

5. A mold member according to claim 1 wherein the mold member further includes an integral hollow support extending between the mold member inner and outer walls for reinforcement of the mold.

6. A mold member according to claim 1 wherein the mold member further includes integral stand-offs extending between the mold member inner and outer walls.

7. A mold member according to claim 5 wherein said hollow support is a first hollow support, and further comprising a plurality of additional hollow supports spaced-apart and extending between said outer wall of the mold member and said inner wall of the mold member for reinforcement of the mold member and for causing augmentation of the flow of coolant fluid within the hollow interior.

8. A mold member according to claim 1 wherein said outer wall is formed with grooves which protrude into said hollow interior for causing augmentation of the flow of coolant fluid within the hollow interior.

9. A mold member according to claim 1 and further comprising a holder to which the mold member is releasably secured, the holder defining cooling passages in communication with said inlet and outlet ports.

10. A mold member according to claim 9 further comprising a protruding locator pin mounted in the holder, and the outer wall of the mold member defining a recess for receiving the locator pin.

11. A mold member according to claim 10 wherein the locator pin is of tapered form and the recess is of correspondingly tapered form.

12. A mold member according to claim 10 wherein the recess in the outer wall of the mold member is defined by an encapsulated bushing integrally formed with the mold member.

13. A mold member according to claim 1 wherein the inner wall has a parting line inner face surrounding said cavity, the inner face defining grooves extending to a peripheral edge of said inner face for permitting exhaustion of air from within the mold cavity during blow molding of articles of plastics material.

14. A mold member according to claim 1 wherein the mold cavity has a base end including a knife edge for severing plastics material at said base end of the mold cavity in extrusion blow molding of articles of plastics material.

15. A mold member according to claim 1 and further comprising at least one connector assembly extending between said outer wall and said inner wall, the connector assembly defining an orifice therethrough, and including a hollow insert located in said orifice and partially encapsulated in said connector assembly.

16. A mold member according to claim 15 wherein the connector assembly further includes a porous vent plug communicating with the hollow insert for applying a vacuum to the vent plug for in-mold labelling.

17. A mold member as claimed in claim 1 and further comprising an upstanding handle protrusion located in the mold cavity and adapted to mate with a like protrusion in a mating mold member to produce handleware blow molded articles.

18. A mold member as claimed in claim 1 wherein the hollow body has an open base end portion, and further comprising a base mold member adapted to cooperate with the hollow bodies of two mating mold members to form a closed blow mold.

19. A mold member according to claim 17 wherein the upstanding handle protrusion has a knife edge for severing plastics material disposed between mating handle protrusions during blow molding of articles of plastics material.

20. A mold member as claimed in claim 1 wherein the hollow body is a first hollow body having a cavity defining a portion of an article of plastic material to be blow molded, and further comprising a second like hollow body having a cavity adapted to mate with said first hollow body cavity to define a further portion of said article to be blow molded.
